(19) United States
(12) Patent Application Publication
(10) Pub. No.: US 2008/0035423 A1
(43) Pub. Date: Feb. 14, 2008

(54) Retractable horizontal lifeline assembly

(75) Inventors: Vincent G. Meillet, Red Wing, MN (US); J. Thomas Wolner, Red Wing, MN (US); Damien De Lapeyriere, Saint-Blaise (FR); Charles C. Bryant, Red Wing, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/463,085

(22) Filed: Aug. 8, 2006

(51) Int. Cl. A62B 1/16

(52) U.S. Cl. 182/3

(57) ABSTRACT

A retractable horizontal lifeline assembly includes a lifeline windable about and paid out from a rotatable drum, a tension assembly, and a housing. The housing includes a first connector and is configured and arranged to house the drum, the lifeline wound about the base of the drum, and the tension assembly. The first connector is operatively connected to a first anchorage structure, the lifeline is pulled outward from proximate the housing thereby paying out at least a portion of the lifeline from the drum, a second connector operatively connected to the lifeline is operatively connected to a second anchorage structure, and the tension assembly is used to tension the lifeline and provide indication of the lifeline's tension, the lifeline moving the tension assembly with respect to the housing as the lifeline is being tensioned.

### FIELD OF THE INVENTION

The present invention relates to a retractable horizontal lifeline assembly.

### BACKGROUND OF THE INVENTION

Various occupations place people in precarious positions at relatively dangerous heights thereby creating a need for fall protection and fall arrest apparatus. As a result, many types of safety apparatus have been developed to reduce the likelihood of a fall and/or injuries associated with a fall. Among other things, such apparatus typically include an interconnection between at least one anchorage point and a safety harness worn by a user performing tasks in proximity to the at least one anchorage point. One type of interconnection commonly used is a horizontal lifeline interconnected between at least two anchorage points, along the length of which the user may move and perform tasks. The user's safety harness is typically connected to the horizontal lifeline with a lanyard or other suitable device.

### SUMMARY OF THE INVENTION

One aspect of the present invention provides a retractable horizontal lifeline assembly operatively connected to a first anchorage structure and to a second anchorage structure including a lifeline, a drum, a tension assembly, and a housing. The lifeline has a first end, a second end, and an intermediate portion interconnecting the first end and the second end. The second end includes a second connector. The drum has a base and is rotatable. The first end of the lifeline is operatively connected to the drum and the intermediate portion of the lifeline is windable about and paid out from the base. The housing includes a first connector and is configured and arranged to house the drum, the lifeline wound about the base of the drum, and the tension assembly. The drum is rotatably mounted within the housing, and the tension assembly is mounted within the housing. The first connector is operatively connected to the first anchorage structure, the second end of the lifeline is pulled outward from proximate the housing thereby paying out at least a portion of the intermediate portion from the drum, the second connector is operatively connected to the second anchorage structure, and the tension assembly is used to tension the lifeline.

Another aspect of the present invention provides a retractable horizontal lifeline assembly operatively connected to a first anchorage structure and to a second anchorage structure including a lifeline, a drum, a housing, a brake assembly, a pinion gear, and a pawl. The lifeline has a first end, a second end, and an intermediate portion interconnecting the first end and the second end. The second end includes a second connector. The drum has a base and is rotatable. The first end of the lifeline is operatively connected to the drum and the intermediate portion of the lifeline is windable about and paid out from the base. The housing includes a first connector and is configured and arranged to house the drum and the lifeline wound about the base of the drum. The drum is rotatably mounted within the housing. The brake assembly is operatively connected to the drum and includes a main plate having first teeth. The pinion gear has second teeth in cooperation with the first teeth whereby when the main plate rotates the first teeth engage the second teeth to cause the pinion gear to rotate. The pawl is pivotally mounted with respect to the housing proximate the pinion gear and has an engaging position and a releasing position. The engaging position engages the second teeth preventing the pinion gear from rotating in a first direction, and the releasing position releases the second teeth allowing the pinion gear to rotate in the first direction. When the pinion gear is engaged by the pawl, the main plate is also prevented from rotating in a second direction.

Another aspect of the present invention provides a retractable horizontal lifeline assembly operatively connected to a first anchorage structure and to a second anchorage structure including a lifeline, a drum, a tension assembly, and a housing. The lifeline has a first end, a second end, and an intermediate portion interconnecting the first end and the second end. The second end includes a second connector. The drum has a base and is rotatable. The first end of the lifeline is operatively connected to the drum and the intermediate portion of the lifeline is windable about and paid out from the base. The tension assembly has a roller, a third connector, and a biasing member interconnecting the roller and the third connector. The biasing member places a force upon the roller pulling the roller in a first direction toward the third connector. The lifeline is routed between the roller and the third connector. The housing includes a first connector and is configured and arranged to house the drum, the lifeline wound about the base of the drum, and the tension assembly. The drum is rotatably mounted within the housing, and the third connector is mounted within the housing. The first connector is operatively connected to the first anchorage structure, the second end of the lifeline is pulled outward from proximate the housing thereby paying out at least a portion of the intermediate portion from the drum, the second connector is operatively connected to the second anchorage structure, and the tension assembly is used to tension the lifeline and provide indication of the lifeline's tension. The lifeline moves the tension assembly with respect to the housing as the lifeline is being tensioned. As the lifeline is tensioned, the lifeline pulls the roller in a second direction away from the third connector. The roller provides indication of the lifeline's tension.

Another aspect of the present invention provides a tension indicator assembly including a housing, a roller, a connector mounted within the housing, and a biasing member interconnecting the roller and the connector within the housing. The biasing member places a force upon the roller pulling the roller in a first direction toward the connector. A lifeline is routed between the roller and the connector. When at least a portion of the lifeline is paid out of the housing and operatively connected between two anchorage structures and the lifeline is tensioned, the lifeline pulls the roller in a second direction away from the connector, the roller providing indication of the lifeline's tension.

Another aspect of the present invention provides a method of installing a retractable horizontal lifeline assembly to a first anchorage structure and to a second anchorage structure. The retractable horizontal lifeline assembly includes a lifeline, a drum, a tension assembly, and a housing. The lifeline has a first end, a second end, and an intermediate portion interconnecting the first end and the second end. The second end includes a second connector. The drum has a base and is rotatable. The first end of the lifeline is operatively connected to the drum and the intermediate portion of the lifeline is windable about and paid out from the base. The housing includes a first connector and is configured and arranged to house the drum, the lifeline wound about the base of the drum, and the tension assembly. The first connector of the housing is connected to the first anchorage structure, at least a portion of the lifeline is paid out from the drum and the housing, the second connector of the second end of the lifeline is connected to the second anchorage structure, and the lifeline is tensioned with the tension assembly.

### BRIEF DESCRIPTION OF THE DRAWINGS

FIG. 1 is a side view of a retractable horizontal lifeline assembly constructed according to the principles of the present invention connected to anchorage structures;

FIG. 2 is a top view of the retractable horizontal lifeline assembly shown in FIG. 1 connected to anchorage structures;

FIG. 3 is an exploded perspective view of the retractable horizontal lifeline assembly shown in FIG. 1;

FIG. 4 is a rear perspective view of the retractable horizontal lifeline assembly shown in FIG. 1;

FIG. 5 is a front perspective view of the retractable horizontal lifeline assembly shown in FIG. 1;

FIG. 6 is a rear perspective view of the retractable horizontal lifeline assembly shown in FIG. 1 with its housing removed;

FIG. 7 is a front perspective view of the retractable horizontal lifeline assembly shown in FIG. 1 with its housing removed;

FIG. 8 is a side view of a brake assembly, a locking assembly, and a tension and fall indictor assembly of the retractable horizontal lifeline assembly shown in FIG. 1;

FIG. 9 is a side view of the locking assembly shown in FIG. 8;

FIG. 10 is a bottom perspective view of a drum of the retractable horizontal lifeline assembly shown in FIG. 1;

FIG. 11 is a side view of the drum of the retractable horizontal lifeline assembly shown in FIG. 10 with a reserve of lifeline;

FIG. 12 is a top perspective view of the drum of the retractable horizontal lifeline assembly with the reserve of lifeline shown in FIG. 11;

FIG. 13 is a perspective view of a portion of the drum of the retractable horizontal lifeline assembly with the reserve of lifeline shown in FIG. 12 showing a connector of the drum;

FIG. 14 is a side view of the drum of the retractable horizontal lifeline assembly shown in FIG. 10 with a lifeline;

FIG. 15 is a top perspective view of the drum of the retractable horizontal lifeline assembly shown in FIG. 10 with a lifeline;

FIG. 16 is a side view of another embodiment retractable horizontal lifeline assembly constructed according to the principles of the present invention with its housing removed;

FIG. 17 is a front perspective view of the retractable horizontal lifeline assembly shown in FIG. 16;

FIG. 18 is a side view of the retractable horizontal lifeline assembly shown in FIG. 16 with its motor spring housing removed;

FIG. 19 is a front perspective view of the retractable horizontal lifeline assembly shown in FIG. 16 with its motor spring housing removed;

FIG. 20 is a cross sectional view of a brake assembly operatively connected to a drum of the retractable horizontal lifeline assembly shown in FIG. 1;

FIG. 21 is a top perspective view of a crank of the retractable horizontal lifeline assembly shown in FIG. 1;

FIG. 22 is a bottom perspective view of the crank shown in FIG. 21 with its handle pivoted inward;

FIG. 23 is a perspective view of a drum of the retractable horizontal lifeline assembly shown in FIGS. 18 and 19;

FIG. 24 is a perspective view of an anchorage connector of the retractable horizontal lifeline assembly shown in FIG. 1 operatively connected to a bracket; and

FIG. 25 is a perspective view of a connector of a drum of the retractable horizontal lifeline assembly shown in FIG. 1.

### DETAILED DESCRIPTION OF A PREFERRED EMBODIMENT

A retractable horizontal lifeline assembly constructed according to the principles of the present invention is designated by the numeral 100 in the drawings.

The retractable horizontal lifeline assembly 100 includes a housing 102 having a first side 104 and a second side 110. The first side 104 includes a first side plate 105 from which sides 108 extend, and the second side 110 includes a second side plate 111 from which sides 112 extend. The sides 108 correspond with the sides 112, and the first side 104 and the second side 110 form a cavity 113 therebetween in which other components of the retractable horizontal lifeline assembly are housed. The first side plate 104 includes a first aperture 106 proximate the top of the first side plate 104 and a second aperture 107 proximate the middle of the first side plate 104. Proximate the tops of the sides 108 and 112, the sides 108 and 112 have semi-circular notches that cooperate to form a third aperture 114. Proximate the fronts of the sides 108 and 112, the sides 108 and 112 have rectangular notches that cooperate to form a fourth aperture 115.

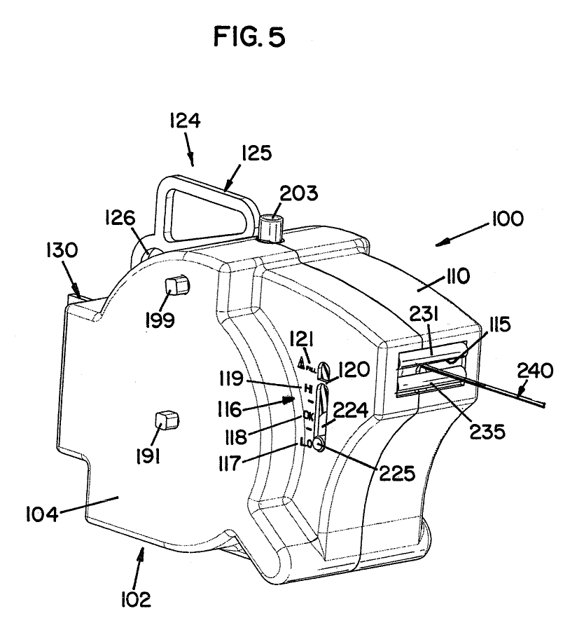

The first side plate 104 also preferably includes a window 116 and at least one indication mark proximate the window 116. The window 116 is preferably positioned proximate the front of the housing 102. As shown in FIG. 5, a “LO” tension indicator 117 is proximate the bottom of the window 116, an “OK” tension indicator 118 is proximate the middle of the window 116, and a “HI” tension indicator 119 is proximate the top of the window 116. A bridge 120 extends across the window 116 proximate the “HI” tension indicator 119, and above the bridge 120 is a fall indicator 121 proximate the top of the window 116 above the “HI” tension indicator 119. The housing 102 is preferably made of plastic.

A first connector plate 153 and a second connector plate 167 cooperate within the cavity 113 of the housing 102 as a frame to which other components of the retractable horizontal lifeline assembly 100 are connected. The first connector plate 153 is preferably generally Y-shaped and includes an angled portion 162 from the top of which an upward extending portion 154 and a sideways extending portion 159 extend. The upward extending portion 154 and the sideways extending portion 159 are both preferably T-shaped, the “T” of the upward extending portion 154 being oriented with the top in an upward orientation and the “T” of the sideways extending portion 159 being oriented with the top in a sideways to the left orientation relative to the housing 102. The upward extending portion 154 includes a first aperture 155 proximate the rear of the “T” top, a second aperture 156 proximate the middle of the “T” top, and a third aperture 157 proximate the front of the “T” top relative to the housing 102. A fourth aperture 158 is located between the second aperture 156 and the third aperture 157 and more proximate the top of the upward extending portion 154. The sideways extending portion 159 includes a first aperture 160 proximate the top of the “T” top and a second aperture 161 proximate the bottom of the “T” top. An aperture 163 is positioned proximate the juncture of the portions 154, 159, and 162. The angled portion 162 includes an aperture 164 proximate the distal end.

The second connector plate 167 is preferably similar to and a mirror image of the first connector plate 153 for ease of manufacture, but it is recognized that the second connector plate 167 may be different than the first connector plate 153. The second connector plate 167 is preferably generally Y-shaped and includes an angled portion 176 from the top of which an upward extending portion 168 and a sideways extending portion 173 extend. The upward extending portion 168 and the sideways extending portion 173 are both preferably T-shaped, the “T” of the upward extending portion 168 being oriented with the top in an upward orientation and the “T” of the sideways extending portion 173 being oriented with the top in a sideways to the left orientation relative to the housing 102. The upward extending portion 168 includes a first aperture 169 proximate the rear of the “T” top, a second aperture 170 proximate the middle of the “T” top, and a third aperture 171 proximate the front of the “T” top relative to the housing 102. A fourth aperture 172 is located between the second aperture 170 and the third aperture 171 and more proximate the top of the upward extending portion 168. The sideways extending portion 173 includes a first aperture 174 proximate the top of the “T” top and a second aperture 175 proximate the bottom of the “T” top. An aperture 177 is positioned proximate the juncture of the portions 168, 173, and 176. The angled portion 176 includes an aperture 178 proximate the distal end.

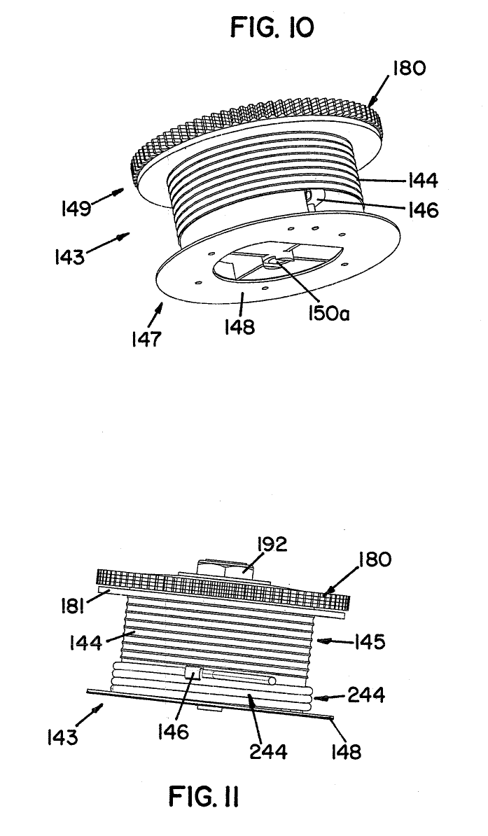

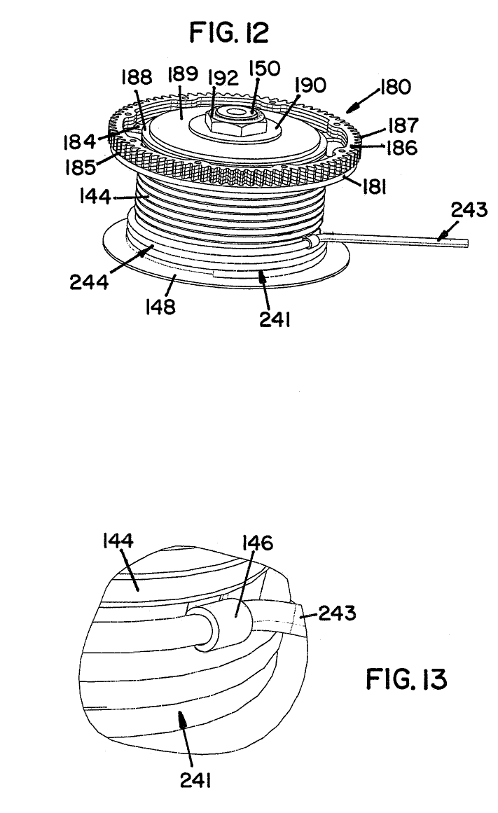

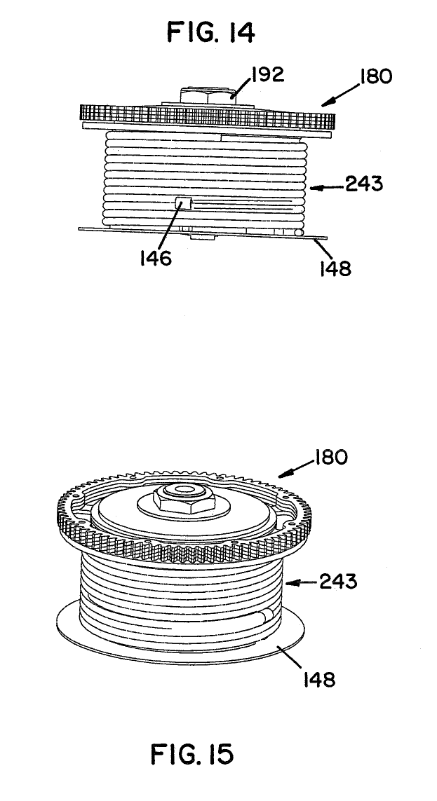

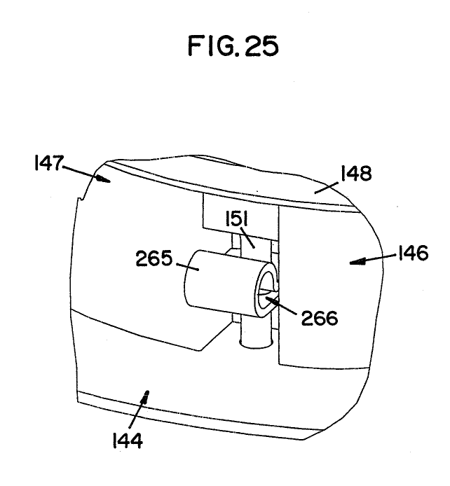

A drum 143, as shown in FIGS. 10-12 and 14-15, includes a cylindrical base 144 with a first side 147 to which a circular plate 148 is connected and a second side 149. A shaft 150 with a bore 150a extends through the base 144 proximate the center of the base 144 and extends outward from the second side 149. Preferably, the shaft 150 is integral with the drum 143 and includes a threaded end 150b proximate the second side 149. A lifeline 240 is wound about the base 144 and because the drum 143 is rotatable, the lifeline 240 may be paid out from the drum 143 and then wound about the base 144 of the drum 143 when it is no longer being used. The lifeline 240 includes a first end 241, a second end 242, and an intermediate portion 243 interconnecting the first end 241 and the second end 242. The lifeline 240 is preferably up to 60 feet long and made of wire cable, webbing, synthetic rope, or any other suitable material. Preferably, the lifeline 240 is ¼ inch thick. The first end 241 is operatively connected to the drum 143 as is well known in the art, the intermediate portion 243 is windable about the base 144, and the second end 242 includes a loop 242a to which a connector 257 may be connected. The base 144 may include optional grooves 145, which help initially guide the intermediate portion 243 about the base 144. Preferably, there are ten grooves 145 to assist in winding the first ten revolutions of lifeline 240 about the base 144. A connector 146, which is preferably a cable tie, may be operatively connected to the base 144 proximate the first side 147. The connector 146 is configured and arranged to be operatively connected to a portion of the intermediate portion 243 a distance from the first end 241, preferably 3 to 4 feet, to create a reserve portion 244 between the connector 146 and the first end 241. As shown in FIG. 25, the connector 146 may be a strap member 265 with apertures 266 at each end, and the base 144 may include a peg 151 extending outward from proximate the first side 147. The strap member 265 is positioned so that the peg 151 is inserted through its apertures 266 to form a loop 267 in the strap member 265. The loop 267 is configured and arranged to cinch about the portion of the intermediate portion 243 thereby preventing the reserve portion 244 from being paid out under normal use. The lifeline 240 may be paid out from the base 144 up to the connector 146 and should a fall occur, the reserve portion 244 is released from the connector 146. Preferably, the connector 146 breaks due to the force of the fall. The drum 143 is preferably made of aluminum.

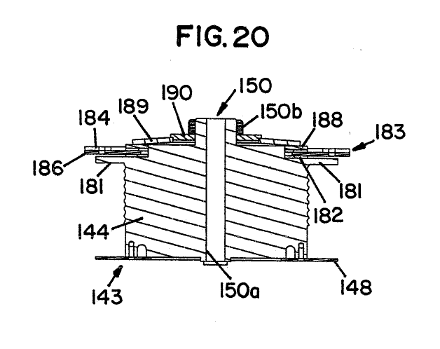

A brake assembly 180, as shown in FIG. 20, includes a back plate 181, a first friction plate 182, a main plate 183 including a gear disk 184 with teeth 185 and a gear ring 186 with teeth 187, a second friction plate 188, a front plate 189, and a spring disk 190, which are all preferably circular disks having central bores through which the shaft 150 extending outward from the second side 149 of the drum 143 is inserted. The gear ring 186 is operatively connected, preferably with rivets or by welding, to the gear disk 184 and because it is a ring rather than a plate, it provides added thickness to the teeth 185 of the gear disk 184 without adding too much weight to the main plate 183. The back plate 181 is placed proximate the second side 149 of the drum 143 and is preferably secured thereto with a fastener such as a screw. A nut 192 is operatively connected to the threaded end 150b of the shaft 150 to secure the brake assembly components to the shaft 150. The spring disk 190, the front plate 189, the second friction plate 188, the main plate 183 (including the gear ring 186 and the gear disk 184), the first friction plate 182, and the back plate 181 are compressed together between the nut 192 and the drum 143, and the spring disk 190 is adjusted to a desired calibrated force by the nut 192 as is well known in the art. The brake assembly 180 is proximate the second side 149 of the drum 143, and the brake assembly 180 and the drum 143 are positioned between the connector plates 153 and 167. Preferably, the first connector plate 153 is proximate the brake assembly 180 and the second connector plate 167 is proximate the first side 147 of the drum 143. The brake assembly 180 is an example of a suitable brake assembly and it is recognized that other brake assemblies known in the art may be used.

A shaft 193 extends through aperture 163 of the first connector plate 153, through the bore 150a of the shaft 150, and through aperture 177 of the second connector plate 167 to operatively connect the drum 143 and the brake assembly 180 between the connector plates 153 and 167. A bushing 194 is preferably positioned between each end of the shaft 193 and the corresponding connector plates 153 and 167 to reduce the friction between the shaft 193 and the connector plates 153 and 167. The bushing 194 may be made of plastic, brass, or any suitable material. A second male connector 191 is operatively connected to the shaft 193 and extends through aperture 163 in the first connector plate 153 and aperture 107 in the housing 102 and is used to wind the lifeline 240 about drum 143. Preferably, the second male connector 191 is integral with the end of the shaft 193.

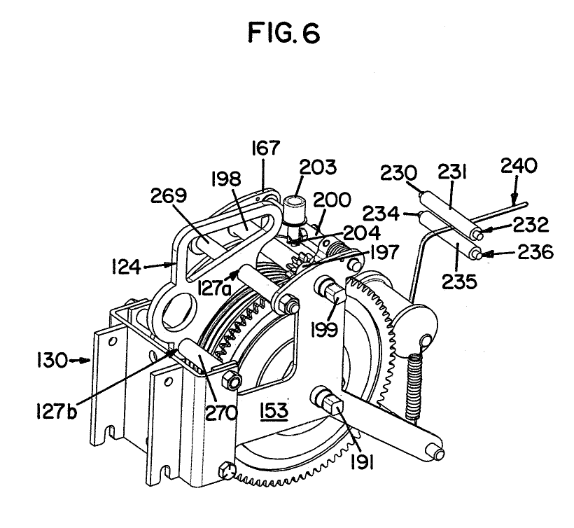

A locking assembly 195, as shown in FIGS. 6 and 8-9, includes a pinion gear 196 with teeth 197, which cooperate and mate with the teeth 185 and 187 of the main plate 183 of the brake assembly 180. The pinion gear 196 is operatively connected to a shaft 198 so as the shaft 198 rotates, the pinion gear 196 rotates and vice versa. Further, as the main plate 183 rotates, the pinion gear 196 rotates and vice versa. The shaft 198 extends through apertures 156 and 170 of the connector plates 153 and 167, respectively. A first male connector 199 is operatively connected to an end of the shaft 198 proximate the pinion gear 196, and the first connector plate 153 is positioned between the pinion gear 196 and the first male connector 199, which extends through aperture 106 of the housing 102 and is used to tension the lifeline 240. Preferably, the first male connector 199 is integral with the end of the shaft 198.

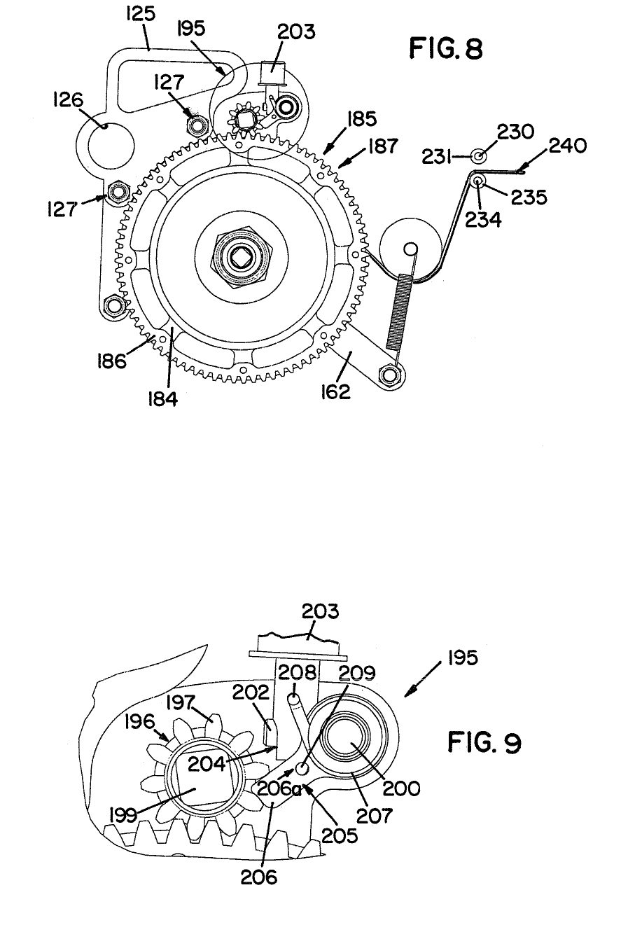

A shaft 200 is parallel to the shaft 198 and extends through apertures 157 and 171 of the connector plates 153 and 167, respectively, and is pivotal therethrough. A pawl 205 has a bore (not shown) through which the shaft 200 is inserted, and the pawl 205 is proximate the first connector plate 153. The pawl 205 is preferably secured to the shaft 200 with a fastener. The pawl 205 also has an extension portion 206 extending outward proximate the bore, and the extension portion 206 has an aperture 206a proximate the bore. A torsion spring 207 is wound about the shaft 200 and is placed between the pawl 205 and the first connector plate 153. A first end 208 of the torsion spring 207 is inserted through the aperture 158 of the first connector plate 153, and a second end 209 of the torsion spring 207 is inserted through the aperture 206a of the pawl 205. The pawl 205 and the shaft 200 pivot together within the apertures 157 and 171 and the torsion spring 207 places a force upon the pawl 205 so that the extension portion 206 is urged in a downward direction to engage the teeth 197 of the pinion gear 196 thereby locking the drum 143 and preventing rotation of the drum 143 in a clockwise direction. The pawl 205 automatically locks the pinion gear 196, allowing the pinion gear 196 to be rotated in a clockwise direction and preventing the pinion gear 196 from being rotated in a counterclockwise direction. The pawl 205 has an engaging position and a releasing position. The engaging position sufficiently engages the teeth 197 of the pinion gear 196 to prevent the pinion gear 196 from rotating in a counterclockwise direction, and the releasing position does not sufficiently engage the teeth 197 thereby allowing the pinion gear 196 to be rotated in a clockwise direction. The direction of the rotation as described herein is relative to the embodiment as shown in FIG. 8, and it is recognized that the direction of rotation may change as the embodiment or the orientation of the embodiment changes.

The pinion gear 196 can be rotated in a clockwise direction and the teeth 197 push the pawl 205 downward away from the pinion gear 196 overcoming the force of the torsion spring 207 thereby allowing the pinion gear 196 to rotate in a clockwise direction. The torsion spring 207 continually places force on the pawl 205 that must be overcome to rotate the pinion gear 196. The pawl 205 creates a mechanical stop of the pinion gear 196 when the pinion gear 196 is rotated in a counterclockwise direction. This assists in tensioning the lifeline 240 because the drum can rotate in a counterclockwise direction but it cannot rotate in a clockwise direction while the pawl 205 engages the pinion gear 196.

The shaft 200 also includes a bore 201 extending axially through the shaft 200 proximate the pawl 205 through which a connector 202 extends through perpendicularly from the shaft 200. A push button 203 includes a notch 204 that straddles the connector 202, and the push button 203 extends through the third aperture 114 formed by the sides 104 and 110 of the housing 102. Because the pawl 205 is biased by the torsion spring 207, the shaft 200 is also biased by the torsion spring 207. When the push button 203 is pressed downward, the connector 202 is pushed downward, which rotates the shaft 200 in a counterclockwise direction thereby also rotating the pawl 205 in a counterclockwise direction, overcoming the force of the torsion spring 207, to release the teeth 197 of the pinion gear 196. The push button 203 is a release mechanism may be used to unlock the drum 143 to pay out the lifeline 240, to rewind the lifeline 240, and to release tension in the lifeline 240. The pinion gear 196 is automatically locked due to the torsion spring 207 placing a force upon the pawl 205 thereby automatically locking the main gear 183 of the brake assembly 180. The push button may be plastic, aluminum, or any other suitable material.

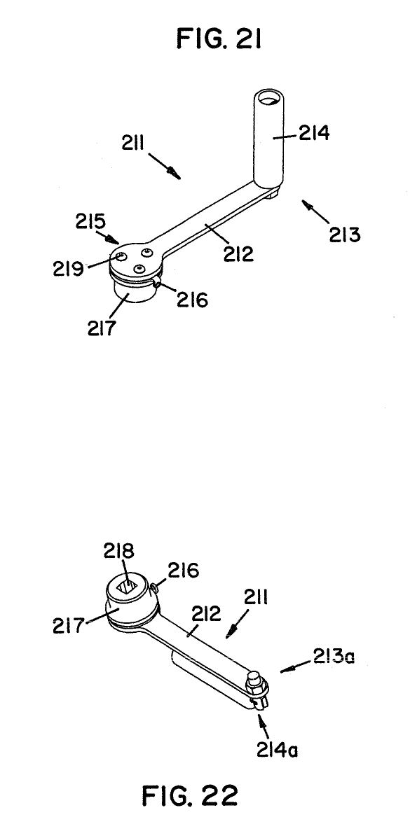

As shown in FIGS. 21 and 22, a crank 211 includes an arm 212 with a first end 213 having an aperture (not shown) through which a fastener 213a extends to pivotally operatively connect a handle 214 thereto. A hinge 214a allows the handle 214 to be pivoted inward toward the arm 212 when not in use. A pocket (not shown) may be operatively connected to or integral with the housing 102 and the crank 211 may be placed therein when not in use. A second end 215 of the arm 212 includes a swivel 216 between the arm 212 and a female connector 217 having a receiver 218. Fasteners 219 connect the swivel 216 and the female connector 217 to the second end 215. The swivel rotates between the arm 212 and the female connector 217 and is configured and arranged to be operatively connected to a connector (not shown) such as a rope or a chain interconnecting the crank 211 and the housing 102. The connector ensures that the crank 211 is not dropped or lost, and the swivel 216 allows the crank 211 to function without interference from the connector because as the arm 212 is rotated about either of the male connectors 191 or 199, the swivel does not rotate thereby keeping the connector from interfering with the rotation of the arm 212. The receiver 218 is configured and arranged to receive the first male connector 199 operatively connected to the shaft 198 of the locking assembly 195 and the second male connector 191 operatively connected to the shaft 193. When the crank 211 is operatively connected to the first male connector 199, the lifeline 240 may be tensioned.

The pawl 205 automatically locks the pinion gear 196, allowing the pinion gear 196 to be rotated in a clockwise direction and preventing the pinion gear 196 from being rotated in a counterclockwise direction. This allows the lifeline 240 to be tensioned incrementally as the crank 211 turns the first male connector 199. The interaction between the gear disk 184 and the pinion gear 196 allows the lifeline 240 to be tensioned with less effort due to the mechanical advantage provided by the preferred 8.5:1 gear ratio between the main plate 183 and the pinion gear 196. When the crank 211 is operatively connected to the second male connector 191 and the pinion gear 196 has been released from the pawl 205, the lifeline 240 may be rewound about the base 144.

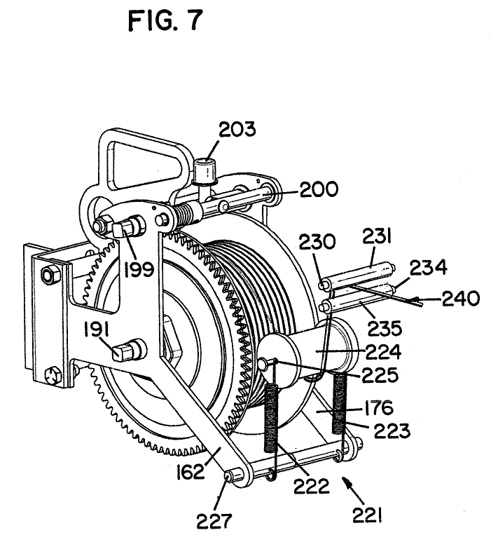

A tension and fall indicator assembly 221, as shown in FIG. 7, includes a cylindrical roller 224 having a first connector 225 at one end and a second connector 226 at its opposite end. The connectors 225 and 226 are preferably pegs extending longitudinally outward from the ends of the roller 224. The first connector 225 extends through the window 116 of the housing 102. A third connector 227 is a shaft that extends through apertures 164 and 178 of the connector plates 153 and 167. A first biasing member 222 is preferably an extension spring that interconnects the first connector 225 and the third connector 227, and a second biasing member 223 is preferably an extension spring that interconnects the second connector 226 and the third connector 227. Although two biasing members are shown and described, it is recognized that any suitable number of biasing members may be used. Further, although extension springs are shown and described, it is also recognized that torsion springs, compression springs, disk springs, elastic members, and other types of suitable biasing members may be used. The biasing members 222 and 223 place a force upon the roller 224 that urges the roller 224 downward toward the third connector 227.

A first shaft 230 extends through a bore 232 of a first roller 231, which is proximate the top of the aperture 115 formed by the sides 104 and 110 of the housing 102. The shaft 230 and the roller 231 could also be integral. A second shaft 234 extends through a bore 236 of a second roller 235, which is proximate the bottom of the aperture 115 formed by the sides 104 and 110 of the housing 102. The shaft 234 and the roller 235 could also be integral. The shafts 230 and 234 correspond with indentations in the sides 104 and 110 of the housing 102 proximate the top and the bottom of the aperture 115 so that the shafts 230 and 234 are secured therein between the sides 104 and 110. The rollers 231 and 235 pivot about the shafts 230 and 234, respectively, as the lifeline 240 is paid out of the housing 102 and wound back up into the housing 102 to assist in preventing wear on the housing 102 and on the lifeline 240.

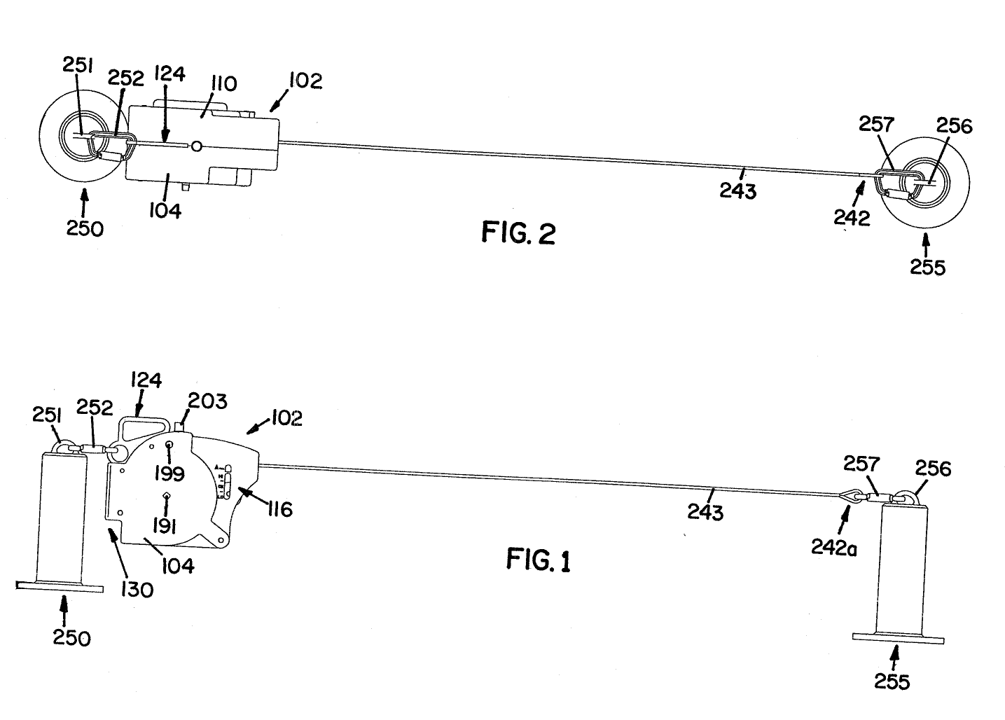

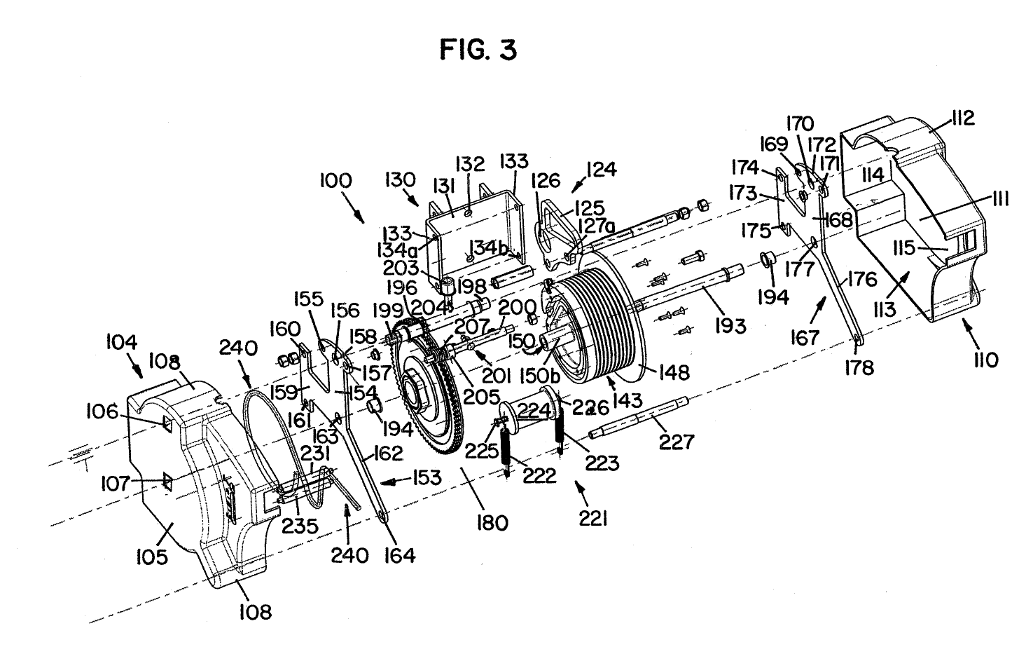

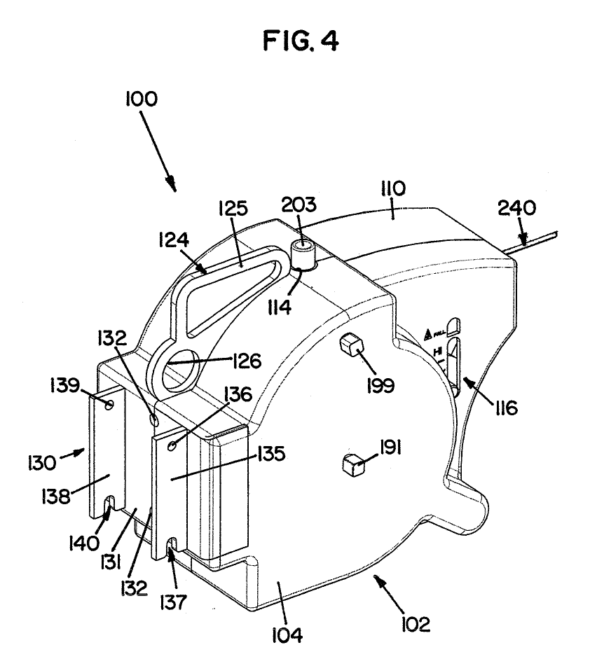

Extending outward from the housing 102 are a first anchorage member 124 and a second anchorage member 130, which provide two options for anchoring the rear of the retractable horizontal lifeline assembly 100 as shown in FIGS. 1 and 2. The first anchorage member 124 extends outward proximate the top and the rear of the housing 102 between the sides 104 and 110. The first anchorage member 124 is a plate-like member forming a handle 125 proximate the top and forming an aperture 126 proximate the rear. The handle 125 may be used to carry the retractable horizontal lifeline assembly 100. Alternatively, a handle may be incorporated into the housing. A connector 252 such as a carabiner, a snap hook, or any other suitable connector may be inserted through the aperture 126 for connecting the retractable horizontal lifeline assembly 100 to a connector member 251 of an anchorage structure 250. An aperture 127a is proximate the bottom and the handle 125, and an aperture 127b is proximate the bottom and the aperture 126. The first anchorage member 124 is preferably made of steel.

The second anchorage member 130 is a U-shaped member having a base plate 131 with side plates 133 extending outward perpendicularly from opposing sides of the base plate 131 toward the front of the retractable horizontal lifeline assembly 100 thus forming a U-shape. The base plate 131 includes apertures 132, preferably one aperture 132 proximate the top of the base plate 131 and one aperture 132 proximate the bottom of the base plate 131. Each of the side plates 133 includes apertures 134a and 134b, aperture 134a proximate the top of the side plate 133 and aperture 134b proximate the bottom of the side plate 133. A first flange 135 extends outward perpendicularly from the base plate 131 between the apertures 132 and a side plate 133 toward the rear of the retractable horizontal lifeline assembly 100. The first flange 135 includes an aperture 136 proximate the top of the first flange 135 and a notch 137 proximate the bottom of the first flange 135. A second flange 138 extends outward perpendicularly from the base plate 131 between the apertures 132 and the other side plate 133 toward the rear of the retractable horizontal lifeline assembly 100. The second flange 138 includes an aperture 139 proximate the top of the second flange 138 and a notch 140 proximate the bottom of the second flange 138. The second anchorage member 130 may be used to connect to an anchorage structure such as brackets, stanchions, I-beams, posts, and other suitable structures well known in the art. The second anchorage member 130 is preferably made of steel.

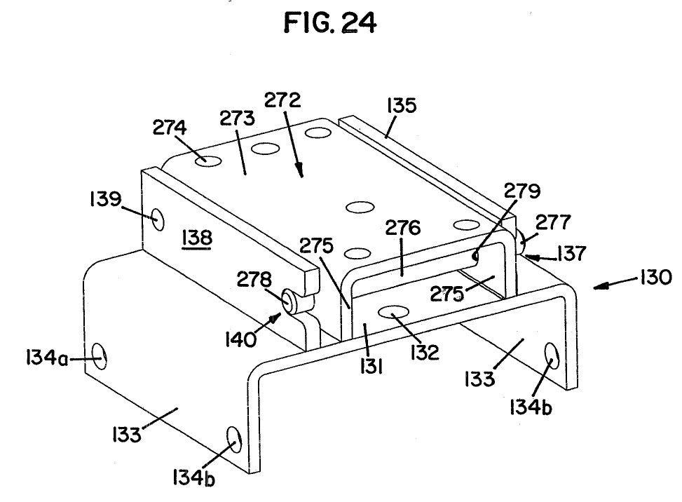

An example of a suitable bracket 272 to which the second anchorage member 130 may be attached is shown in FIG. 24. Such a bracket 272 is commonly operatively connected to tripods, davit arms, and other portable safety anchorage devices such as those sold by D B Industries, Inc. of Red Wing, Minn. The bracket 272 is preferably a U-shaped member having a base plate 273 with side plates 275 extending outward perpendicularly from opposing sides of the base plate 273 outward from the portable safety anchorage device to which it is operatively connected. The side plates 275 of the bracket 272 fit between the flanges 135 and 138 of the second anchorage member 130. The base plate 173 includes a plurality of apertures 274 through which fasteners are inserted to operatively connect the bracket 272 to the portable safety anchorage device. The side plates 275 include apertures (not shown) proximate the top and apertures 279 proximate the bottom. A shaft 276 includes a first end 277 and a second end 278 that extend through the apertures 279.

As shown in FIG. 6, the anchorage members 124 and 130 are operatively connected to the connector plates 153 and 167 and extend outward through the housing 102 between the sides 104 and 110. A rod 269 extends through aperture 155 of the first connector plate 153, through aperture 127a of the first anchorage member 124, and through aperture 169 of the second connector plate 167 and each end of the rod 269 is secured with fasteners. A rod 270 extends through aperture 134a of the side plate 133, through aperture 160 of the first connector plate 153, through aperture 127b of the first anchorage member 124, through aperture 174 of the second connector plate 167, and through aperture 134a of the side plate 133 and each end of the rod 270 is secured with fasteners. A fastener is inserted through aperture 134b of the side plate 133 and through aperture 161 of the first connector plate 153, and a fastener is inserted through aperture 134b of the other side plate 133 and through aperture 175 of the second connector plate 167.

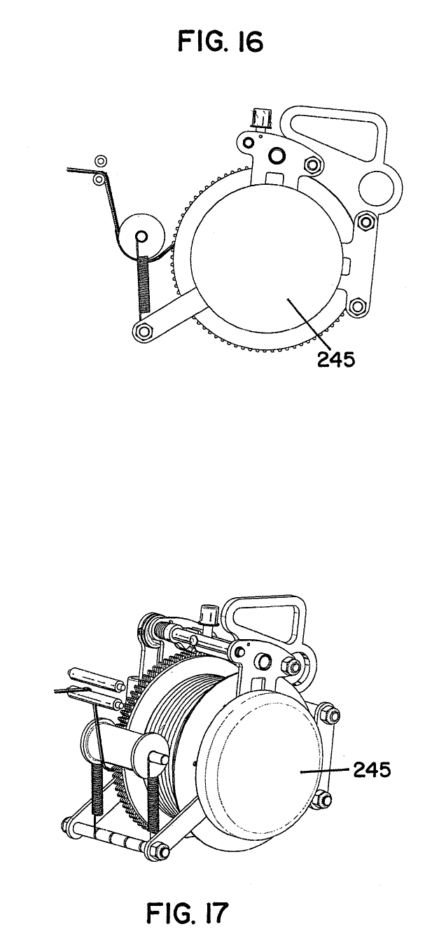

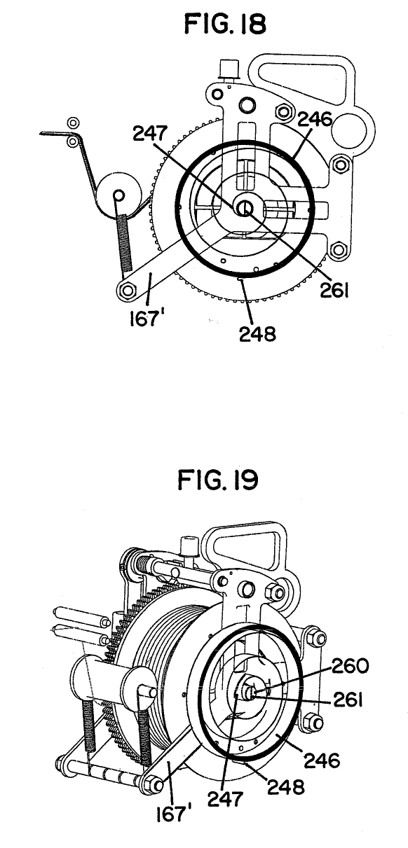

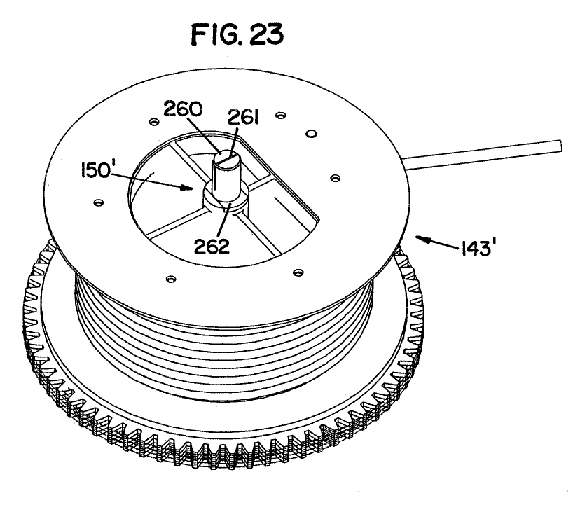

Optionally, as shown in FIGS. 16-19, a motor spring housing 245 operatively connected to the second connector plate 167′ houses a motor spring 246 having a first end 147 and a second end 248. As shown in FIG. 23, a shaft 260 includes a slot 261 proximate one end, a flange 262 extending outward proximate the middle, and a male connector (not shown) proximate the opposite end. The male connector (not shown) is inserted into a bore (not shown) of the shaft 150′ of the drum 143′. The end including the slot 261 is inserted through an aperture (not shown) in the second connector plate 167′. Therefore, the shaft 260 is sandwiched between the drum 143′ and the second connector plate 167′. The first end 247 of the motor spring 246 is inserted into the slot 261 in the shaft 260 and the second end 248 is operatively connected to the motor spring housing 245 such as by a fastener as is well known in the art. The motor spring may also be operatively connected to the drum and to the housing by other suitable means well known in the art. The motor spring 246 places a force upon the drum thereby rotating the drum when tension is released from the lifeline thereby automatically winding the lifeline about the drum. The motor spring 246 winds more tightly as the lifeline is paid out from the drum, and because the motor spring wants to unwind, when tension is released from the lifeline, the motor spring unwinds thus automatically winding the lifeline about the drum.

The lifeline 240 is preferably routed from the rear toward the front and over the top of the drum 143 and then the lifeline 240 extends downward toward the roller 224. The lifeline 240 is routed between the roller 224 and the third connector 227 and then between rollers 231 and 235 out of the housing 102.

The retractable horizontal lifeline assembly of the present invention is a temporary and a portable system that is easily installed, uninstalled, and transportable because it is self-contained and relatively light weight. The lifeline is stored in the housing and the user simply carries the retractable horizontal lifeline assembly by the handle to a desired location.

FIGS. 1 and 2 show the retractable horizontal lifeline assembly 100 operatively connected to a first anchorage structure 250 including a connector member 251 and to a second anchorage structure 255 including a connector member 256. A connector 252 such as a carabiner, a snap hook, a shackle, or any other suitable connector may be used to interconnect the connector member 251 and the first anchorage member 124 through the aperture 126. Alternatively, the second anchorage member 130 may be operatively connected to an anchorage structure such as brackets, stanchions, I-beams, posts, and other suitable structures as is well known in the art. To connect the second anchorage member 130 to the bracket 272, the ends 277 and 278 of the bracket's shaft 276 are slid into the notches 137 and 140, respectively, with the base plate 273 and the side plates 275 between the flanges 135 and 138. A pin (not shown) is inserted through the apertures 136 and 139 of the second anchorage member 130 and the top apertures (not shown) of the bracket 272. Alternatively, apertures 132 could be used to connect other types of brackets operatively connected to a safety device with fasteners as is well known in the art. The second end 242 of the lifeline 240 is then pulled away from the housing 102 thereby paying out the lifeline 240 from the drum 143 and the housing 102. A connector 257 such as a carabiner, a snap hook, or any other suitable connector may be used to interconnect the connector member 256 and the loop 242a of the second end 242 of the lifeline 240.

In order to function properly and safely arrest a fall, the lifeline 240 must be properly tensioned. The crank 211 is operatively connected to the first male connector 199 by inserting the first male connector 199 into the receiver 218. The handle 214 is turned thus rotating the first male connector 199, which in turn rotates the shaft 198 thereby rotating the pinion gear 196, which in turn rotates the gear disk 184 thereby rotating the drum 143 to wind the lifeline 240 more tightly about the base 144. As shown in FIG. 6, the pinion gear 196 is rotated clockwise causing the pawl 205 to pivot downward releasing the teeth 197 of the pinion gear 196. Because the pawl 205 is biased by the torsion spring 207, the pawl 205 is biased so that it will pivot upward to engage the teeth 197 of the pinion gear 196. When rotation of the pinion gear 196 stops, the pawl 205 will pivot upward to engage the teeth 197 thereby locking the mechanism and preventing additional lifeline 240 from being paid out.

As the lifeline 240 becomes more and more taut, the roller 224 will rise. The first connector 225 will likely start out being positioned proximate the “LO” tension indicator 117 and as the lifeline 240 is tensioned, the lifeline 240 becomes more taut and raises the roller 224 thus raising the first connector 225 upward relative to the window 116 of the housing 102. When the first connector 225 is positioned proximate the “OK” tension indicator 118, the lifeline 240 is properly tensioned and the crank can be removed from the first male connector 199. Should a fall occur, the lifeline 240 pulls upward on the roller 224 and the first connector 225 extending through the window 116 moves upward with the roller 224 and breaks the bridge 120 thereby indicating that a fall has occurred.

To release the tension on the lifeline 240, for example when it is desired to disconnect the second end 242 of the lifeline 240 from the anchorage structure, the push button 203 is pressed, which pivots the shaft 200 thereby pivoting the pawl 205 downward to release the teeth 197 of the pinion gear 196. The crank 211 may then be operatively connected to the second male connector 191 by inserting the second male connector 191 into the receiver 218. The handle 214 is then turned thus rotating the second male connector 191, which in turn rotates the shaft 150 thereby rotating the drum 143 in a counter-clockwise direction to wind the lifeline 240 about the base 144. If the motor spring 246 is used, when the push button 203 is pressed, thereby unlocking the pinion gear 196, the motor spring 246 will rotate the drum 143 to automatically wind the lifeline 240 about the base 144.

Should a fall occur, the weight of the user(s) exerts force on the lifeline 240 forcing the drum 143 to rotate and pay out a few feet of the lifeline 240, preferably two turns of the drum 143, but because the main plate 183 of the brake assembly 180 is fixed due to the locking assembly 195, the brake assembly 180 absorbs energy from the force of the fall and also limits the load on the anchorage structures. Without the reserve portion 244 of the lifeline 240, when the entire available length of the lifeline 240 is paid out, there is no additional lifeline 240 to allow the drum 143 to rotate so the brake assembly 180 would not become activated and the impact of the fall would seriously injure the user. The reserve portion 244 is only released in the event of a fall, which causes the connector 146 to release the reserve portion 244, not during normal use such as when the user pays out the lifeline 240 during installation of the system.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A retractable horizontal lifeline assembly operatively connected to a first anchorage structure and to a second anchorage structure, comprising:
a) a lifeline having a first end, a second end, and an intermediate portion interconnecting the first end and the second end, the second end including a second connector;
b) a drum having a base and being rotatable, the first end of the lifeline being operatively connected to the drum and the intermediate portion of the lifeline being windable about and paid out from the base;
c) a tension assembly;
d) a housing including a first connector and being configured and arranged to house the drum, the lifeline wound about the base of the drum, and the tension assembly, the drum being rotatably mounted within the housing, the tension assembly being mounted within the housing; and
e) wherein the first connector is operatively connected to the first anchorage structure, the second end of the lifeline is pulled outward from proximate the housing thereby paying out at least a portion of the intermediate portion from the drum, the second connector is operatively connected to the second anchorage structure, and the tension assembly is used to tension the lifeline.

2. The retractable horizontal lifeline assembly of claim 1, wherein the tension assembly includes a tension indicator providing indication of the lifeline's tension and the lifeline moves the tension indicator with respect to the housing as the lifeline is being tensioned.

3. The retractable horizontal lifeline assembly of claim 1, wherein the lifeline is selected from the group consisting of wire cable, webbing, and synthetic rope.

4. The retractable horizontal lifeline assembly of claim 1, wherein the base includes grooves assisting in evenly winding the lifeline initially around the base.

5. The retractable horizontal lifeline assembly of claim 1, wherein the base includes a connector operatively connected to a portion of the intermediate portion of the lifeline a distance from the first end to create a reserve portion of lifeline between the connector and the first end, wherein the lifeline may be paid out from the base up to the connector and should a fall occur, the reserve portion is released from the connector.

6. The retractable horizontal lifeline assembly of claim 1, wherein the tension assembly includes a tension indicator comprising:
a) a roller;
b) a third connector mounted within the housing;
c) a biasing member interconnecting the roller and the third connector, the biasing member placing a force upon the roller pulling the roller in a first direction toward the third connector; and
d) the lifeline being routed between the roller and the third connector, wherein as the lifeline is tensioned, the lifeline pulls the roller in a second direction away from the third connector, the roller providing indication of the lifeline's tension.

7. The retractable horizontal lifeline assembly of claim 6, wherein the biasing member extends vertically within the housing and perpendicularly with respect to the lifeline as the lifeline is paid out of the housing.

8. The retractable horizontal lifeline assembly of claim 6, wherein the housing includes a window through which the roller can be viewed thereby providing indication of the lifeline's tension.

9. The retractable horizontal lifeline assembly of claim 6, wherein the roller includes a third end and a fourth end and the biasing member includes a first biasing member and a second biasing member, the first biasing member interconnecting the third end and the third connector, the second biasing member interconnecting the fourth end and the third connector.

10. The retractable horizontal lifeline assembly of claim 9, wherein the housing includes a window through which the third end of the roller extends thereby providing indication of the lifeline's tension.

11. The retractable horizontal lifeline assembly of claim 1, further comprising a brake assembly operatively connected to the drum, the brake assembly absorbing energy and limiting a load on the anchorage structures should a fall occur.

12. The retractable horizontal lifeline assembly of claim 11, wherein the brake assembly is housed within the housing.

13. The retractable horizontal lifeline assembly of claim 1, wherein the tension assembly includes a brake assembly including a main plate having first teeth and includes a locking assembly comprising:
a) a pinion gear having second teeth in cooperation with the first teeth whereby when the main plate rotates the first teeth engage the second teeth to cause the pinion gear to rotate; and
b) a pawl pivotally mounted with respect to the housing proximate the pinion gear and having an engaging position and a releasing position, the engaging position engaging the second teeth preventing the pinion gear from rotating in a first direction, the releasing position releasing the second teeth allowing the pinion gear to rotate in the first direction, wherein when the pinion gear is engaged by the pawl, the main plate is also prevented from rotating in a second direction.

14. The retractable horizontal lifeline assembly of claim 13, further comprising:
a) a spring operatively connected to the pawl, the spring placing a force upon the pawl to bias the pawl in the engaging position; and
b) a release mechanism operatively connected to the pawl, the release mechanism overcoming the force of the spring to place the pawl in the releasing position.

15. The retractable horizontal lifeline assembly of claim 13, further comprising a crank releasably operatively connectable to the pinion gear to rotate the pinion gear to tension the lifeline with reduced effort and releasably operatively connectable to the drum to rotate the drum to rewind the lifeline about the base of the drum.

16. The retractable horizontal lifeline assembly of claim 13, wherein the pinion gear is rotatable to tension the lifeline with reduced effort.

17. The retractable horizontal lifeline assembly of claim 16, further comprising a crank releasably operatively connectable to the pinion gear to tension the lifeline.

18. The retractable horizontal lifeline assembly of claim 1, wherein the drum is rotatable to rewind the lifeline about the base of the drum.

19. The retractable horizontal lifeline assembly of claim 18, further comprising a crank releasably operatively connectable to the drum to rewind the lifeline.

20. The retractable horizontal lifeline assembly of claim 1, further comprising a motor spring operatively connected to the drum and placing a force upon the drum, the motor spring automatically winding the lifeline about the drum when tension is released from the lifeline.

21. The retractable horizontal lifeline assembly of claim 1, wherein the housing includes a handle configured and arranged to assist in carrying the retractable horizontal lifeline assembly.

22. The retractable horizontal lifeline assembly of claim 1, wherein the first connector includes a handle configured and arranged to assist in carrying the retractable horizontal lifeline assembly.

23. The retractable horizontal lifeline assembly of claim 1, wherein the first connector is configured and arranged to receive a connector selected from the group consisting of a carabiner, a snap hook, and a shackle.

24. The retractable horizontal lifeline assembly of claim 1, wherein the first connector is configured and arranged to releasably operatively connect to an anchorage structure selected from the group consisting of a bracket, a stanchion, an I-beam, and a post.

25. A retractable horizontal lifeline assembly operatively connected to a first anchorage structure and to a second anchorage structure, comprising:
a) a lifeline having a first end, a second end, and an intermediate portion interconnecting the first end and the second end, the second end including a second connector;
b) a drum having a base and being rotatable, the first end of the lifeline being operatively connected to the drum and the intermediate portion of the lifeline being windable about and paid out from the base;
c) a housing including a first connector and being configured and arranged to house the drum and the lifeline wound about the base of the drum, the drum being rotatably mounted within the housing;
d) a brake assembly operatively connected to the drum including a main plate having first teeth;
e) a pinion gear having second teeth in cooperation with the first teeth whereby when the main plate rotates the first teeth engage the second teeth to cause the pinion gear to rotate; and
f) a pawl pivotally mounted with respect to the housing proximate the pinion gear and having an engaging position and a releasing position, the engaging position engaging the second teeth preventing the pinion gear from rotating in a first direction, the releasing position releasing the second teeth allowing the pinion gear to rotate in the first direction, wherein when the pinion gear is engaged by the pawl, the main plate is also prevented from rotating in a second direction.

26. The retractable horizontal lifeline assembly of claim 25, further comprising:
a) a spring operatively connected to the pawl, the spring placing a force upon the pawl to bias the pawl in the engaging position; and
b) a release mechanism operatively connected to the pawl, the release mechanism overcoming the force of the spring to place the pawl in the releasing position.

27. A retractable horizontal lifeline assembly operatively connected to a first anchorage structure and to a second anchorage structure, comprising:
a) a lifeline having a first end, a second end, and an intermediate portion interconnecting the first end and the second end, the second end including a second connector;
b) a drum having a base and being rotatable, the first end of the lifeline being operatively connected to the drum and the intermediate portion of the lifeline being windable about and paid out from the base;
c) a tension assembly including a tension indicator having a roller, a third connector, and a biasing member interconnecting the roller and the third connector, the biasing member placing a force upon the roller pulling the roller in a first direction toward the third connector, the lifeline being routed between the roller and the third connector;
d) a housing including a first connector and being configured and arranged to house the drum, the lifeline wound about the base of the drum, and the tension assembly, the drum being rotatably mounted within the housing, the third connector being mounted within the housing; and
e) wherein the first connector is operatively connected to the first anchorage structure, the second end of the lifeline is pulled outward from proximate the housing thereby paying out at least a portion of the intermediate portion from the drum, the second connector is operatively connected to the second anchorage structure, and the tension assembly is used to tension the lifeline and provide indication of the lifeline's tension, the lifeline moving the tension indicator with respect to the housing as the lifeline is being tensioned, wherein as the lifeline is tensioned, the lifeline pulls the roller in a second direction away from the third connector, the roller providing indication of the lifeline's tension.

28. The retractable horizontal lifeline assembly of claim 27, wherein the biasing member extends vertically within the housing and perpendicularly with respect to the lifeline as the lifeline is paid out of the housing.

29. The retractable horizontal lifeline assembly of claim 27, wherein the housing includes a window through which the roller can be viewed thereby providing indication of the lifeline's tension.

30. The retractable horizontal lifeline assembly of claim 27, wherein the roller includes a third end and a fourth end and the biasing member includes a first biasing member and a second biasing member, the first biasing member interconnecting the third end and the third connector, the second biasing member interconnecting the fourth end and the third connector.

31. The retractable horizontal lifeline assembly of claim 30, wherein the housing includes a window through which the third end of the roller extends thereby providing indication of the lifeline's tension.

32. The retractable horizontal lifeline assembly of claim 31, wherein the housing includes a bridge extending through the window, the third end of the roller breaking the bridge when a fall occurs to provide indication that a fall has occurred.

33. The retractable horizontal lifeline assembly of claim 27, further comprising a brake assembly operatively connected to the drum, the brake assembly absorbing energy and limiting a load on the anchorage structures should a fall occur.

34. A tension indicator assembly, comprising:
a) a housing;
b) a roller;
c) a connector mounted within the housing;
d) a biasing member interconnecting the roller and the connector within the housing, the biasing member placing a force upon the roller pulling the roller in a first direction toward the connector; and
e) a lifeline being routed between the roller and the connector, wherein when at least a portion of the lifeline is paid out of the housing and operatively connected between two anchorage structures and lifeline is tensioned, the lifeline pulls the roller in a second direction away from the connector, the roller providing indication of the lifeline's tension.

35. The tension indicator assembly of claim 34, further comprising a housing in which the roller, the connector, and the biasing member are housed, the housing including a window through which the roller can be viewed thereby providing indication of the lifeline's tension.

36. The tension indicator assembly of claim 35, wherein the housing includes at least one indication mark proximate the window indicating when the lifeline is properly tensioned.

37. The tension indicator assembly of claim 35, wherein the housing includes at least one indication mark proximate the window indicating when the lifeline has been subjected to a force sufficient to take the lifeline out of service.

38. The tension indicator assembly of claim 34, wherein the roller includes a third end and a fourth end and the biasing member includes a first biasing member and a second biasing member, the first biasing member interconnecting the third end and the third connector, the second biasing member interconnecting the fourth end and the third connector.

39. A method of installing a retractable horizontal lifeline assembly to a first anchorage structure and to a second anchorage structure, the retractable horizontal lifeline assembly having a lifeline having a first end, a second end, and an intermediate portion interconnecting the first end and the second end, the second end including a second connector, a drum having a base and being rotatable, the first end of the lifeline being operatively connected to the drum and the intermediate portion of the lifeline being windable about and paid out from the base, a tension assembly, a housing including a first connector and being configured and arranged to house the drum, the lifeline wound about the base of the drum, and the tension assembly, comprising:
a) connecting the first connector of the housing to the first anchorage structure;
b) paying out at least a portion of the lifeline from the drum and the housing;
c) connecting the second connector of the second end of the lifeline to the second anchorage structure; and
d) tensioning the lifeline with the tension assembly.

40. The method of claim 39, wherein the retractable horizontal lifeline assembly has a motor spring interconnecting the housing and the drum and placing a force upon the drum to automatically wind the lifeline about the base of the drum when tension is released on the lifeline.

41. The method of claim 39, wherein the tension assembly has a biasing member interconnecting a roller and a third connector, the third connector being operatively connected to the housing, the biasing member placing a force upon the roller in a first direction toward the third connector, the lifeline being routed between the roller and the third connector, the lifeline pulling the roller in a second direction away from the third connector when the lifeline is being tensioned, the roller providing indication of the lifeline's tension.

42. The method of claim 39, wherein the retractable horizontal lifeline assembly has a brake assembly and a locking assembly, the brake assembly including a main plate with first teeth, the locking assembly including a pinion gear and a pawl, the pinion gear having second teeth in cooperation with the first teeth whereby when the main plate rotates the first teeth engage the second teeth to cause the pinion gear to rotate, the pawl being pivotally mounted with respect to the housing proximate the pinion gear and having an engaging position and a releasing position, the engaging position engaging the second teeth preventing the pinion gear from rotating in a first direction, the releasing position releasing the second teeth allowing the pinion gear to rotate in the first direction, wherein when the pinion gear is engaged by the pawl, the main plate is also prevented from rotating in a second corresponding direction.

43. The method of claim 42, wherein the locking assembly has a push button operatively connected to the pawl, further comprising pressing the push button to release the pawl from the pinion gear thereby unlocking the pinion gear and the brake assembly.

44. The method of claim 42, wherein a first mating connector is operatively connected to the pinion gear and is accessible through an aperture in the housing, further comprising operatively connecting a crank to the first mating connector, turning the first mating connector with the crank thereby turning the pinion gear to tension the lifeline.

45. The method of claim 39, wherein a second mating connector is operatively connected to the drum and is accessible through an aperture in the housing, further comprising operatively connecting a crank to the second mating connector, turning the second mating connector with the crank thereby turning the drum to wind the lifeline about the drum.
